(19) United States
(12) Patent Application Publication
(10) Pub. No.: US 2024/0396229 A1
(43) Pub. Date: Nov. 28, 2024

(54) BUILDING-BLOCK ANTENNA STRUCTURES AND METHODS

(71) Applicant: TAOGLAS GROUP HOLDINGS LIMITED, Enniscorthy (IE)

(72) Inventors: Yung Sheng Tseng, Taoyuan City (TW); Chien Hua Tseng, Tainan City (TW)

(21) Appl. No.: 18/664,588

(22) Filed: May 15, 2024

Related U.S. Application Data
(60) Provisional application No. 63/468,589, filed on May 24, 2023.

(51) Int. Cl. H01Q 21/06; H01Q 21/00; H01Q 21/28

(52) U.S. Cl. CPC H01Q 21/065; H01Q 21/0087; H01Q 21/28

(57) ABSTRACT

Building-block antenna structures as well as systems and methods for implementing these antenna structures are disclosed. In one embodiment, the building-block antenna structure includes an outer antenna structure having one or more outer antenna feeds and an outer antenna radiator. The outer antenna structure further includes an inner antenna accommodating perimeter with the inner antenna accommodating perimeter further including one or more feed clearance areas that are configured to accommodate one or more inner antenna feeds. The building-block antenna structure also includes an inner antenna structure having a perimeter that is similar in shape to the inner antenna accommodating perimeter. The inner antenna structure also includes one or more inner antenna feeds and an inner antenna radiator. The outer antenna structure has a similar thickness as the inner antenna structure with the outer antenna structure also operating at a different frequency band than the inner antenna structure.

### CROSS-REFERENCE TO RELATED APPLICATIONS

This application claims the benefit of priority to U.S. Provisional Patent Application Ser. No. 63/468,589 filed May 24, 2023, of the same title, the contents of which being incorporated herein by reference in its entirety.

### FIELD

The present disclosure relates generally to multi-band building-block antenna structures, and more particularly in one exemplary aspect to low-profile multi-band building-block antenna structures.

### BACKGROUND

Traditionally, ceramic patch antennas consist of a ceramic dielectric substrate that is mounted over a ground plane and includes a surface metallization that is intended to operate within a given frequency band. For multi-band ceramic patch antennas, the assignee of the present disclosure has traditionally utilized a stacked structure where two (or more) ceramic dielectric substrates are “stacked” on top of one another in order to operate within two (or more) distinct frequency bands. For example, U.S. Pat. No. 11,139,550 entitled “Stack Antenna Structures and Methods” describes so-called three-stack antenna structures which include a first antenna, a second antenna, and a third antenna that are stacked on top of one another in a given order, with each of these antennas having one or more individual feeds that are electrically connected to a circuit board in order to receive, for example, global positioning system (“GPS”) signals. However, these stacked antenna structures may be undesirable in applications in which the overall height of the antenna structure is a design constraint. Accordingly, new techniques are needed which enable multi-band frequency operation within a low-profile antenna structure.

### SUMMARY

The present disclosure satisfies the foregoing needs by providing, inter alia, methods, apparatus and systems for the implementation of low-profile antenna structures that operate within two (or more) distinct frequency bands.

In one aspect, a building-block antenna structure is disclosed. In one embodiment, the building-block antenna structure includes an outer antenna structure having one or more outer antenna feeds and an outer antenna radiator. The outer antenna structure further includes an inner antenna accommodating perimeter with the inner antenna accommodating perimeter further including one or more feed clearance areas, the one or more feed clearance areas configured to accommodate one or more inner antenna feeds. The building-block antenna structure also includes an inner antenna structure having a perimeter that is similar in shape to the inner antenna accommodating perimeter. The inner antenna structure also includes the one or more inner antenna feeds and an inner antenna radiator. The outer antenna structure has a similar thickness as the inner antenna structure with the outer antenna structure also operating at a different frequency band than the inner antenna structure.

In one variant, the one or more outer antenna feeds includes two outer antenna feeds.

In another variant, the two outer antenna feeds are offset from one another by 90 degrees (90°).

In yet another variant, the two outer antenna feeds are offset from one another by 180 degrees (180°).

In yet another variant, the one or more inner antenna feeds includes two inner antenna feeds.

In yet another variant, the two inner antenna feeds are positioned in a similar orientation with the two outer antenna feeds.

In yet another variant, a first inner antenna feed of the two inner antenna feeds is located in a similar orientation with a first outer antenna feed of the two outer antenna feeds and a second inner antenna feed of the two inner antenna feeds is offset with a second outer antenna feed of the two outer antenna feeds by ninety degrees (90°).

In yet another variant, a first inner antenna feed of the two inner antenna feeds is located in a similar orientation with a first outer antenna feed of the two outer antenna feeds and a second inner antenna feed of the two inner antenna feeds is offset with a second outer antenna feed of the two outer antenna feeds by one-hundred eighty degrees (180°).

In yet another variant, the one or more outer antenna feeds comprises a single outer antenna feed and the one or more inner antenna feeds comprises a single inner antenna feed.

In yet another variant, the single outer antenna feed is positioned on a same side of the building-block antenna structure as the single inner antenna feed.

In yet another variant, the single outer antenna feed is offset from the single inner antenna feed by ninety degrees (90°).

In yet another variant, the single outer antenna feed is offset from the single inner antenna feed by one-hundred eighty degrees (180°).

In yet another variant, a plurality of solder mask areas are located on a bottom surface of the outer antenna structure and a bottom surface of the inner antenna structure.

In yet another variant, the inner antenna structure includes one or more first alignment features, the one or more first alignment features being configured to engage with one or more second alignment features located on the outer antenna structure.

In yet another variant, the engagement of the one or more first alignment features with the one or more second alignment features enables a top surface of the inner antenna structure to be coplanar with a top surface of the outer antenna structure.

In yet another variant, the engagement of the one or more first alignment features with the one or more second alignment features enables a bottom surface of the inner antenna structure to be coplanar with a bottom surface of the outer antenna structure.

In another embodiment, the building-block antenna structure includes an outer antenna structure having one or more outer antenna feeds and an outer antenna radiator, the outer antenna structure further includes a middle antenna accommodating perimeter, the middle antenna accommodating perimeter further having one or more middle feed clearance areas, the one or more middle feed clearance areas configured to accommodate one or more middle antenna feeds; a middle antenna structure having an external perimeter that is similar in shape to the middle antenna accommodating perimeter, the middle antenna structure further including an inner antenna accommodating perimeter, the inner antenna accommodating perimeter further having one or more inner feed clearance areas, the one or more inner feed clearance areas being configured to accommodate one or more inner antenna feeds; and an inner antenna structure having a perimeter that is similar in shape to the inner antenna accommodating perimeter, the inner antenna structure including the one or more inner antenna feeds and an inner antenna radiator.

In one variant, the outer antenna structure has a similar thickness as the middle antenna structure and the inner antenna structure.

In another variant, the outer antenna structure operates at a different frequency band then the inner antenna structure.

In yet another variant, the middle antenna structure operates at a different frequency band then both the inner antenna structure and the outer antenna structure.

In another aspect, system level implementations for the building-block antenna referenced above are also disclosed.

In yet another aspect, methods of manufacturing and using the building-block antenna referenced above are also disclosed.

Other features and advantages of the present disclosure will immediately be recognized by persons of ordinary skill in the art with reference to the attached drawings and detailed description of exemplary implementations as given below.

### BRIEF DESCRIPTION OF DRAWINGS

The features, objectives, and advantages of the present disclosure will become more apparent from the detailed description set forth below when taken in conjunction with the drawings, wherein:

FIG. 1A is a top perspective view of a first exemplary building-block antenna, in accordance with the principles of the present disclosure.

FIG. 1B is a top perspective view of the outer antenna structure of the first exemplary building-block antenna of FIG. 1A, in accordance with the principles of the present disclosure.

FIG. 1C is a top perspective view of the inner antenna structure of the first exemplary building block-antenna of FIG. 1A, in accordance with the principles of the present disclosure.

FIG. 1D is a bottom perspective view of the first exemplary building-block antenna of FIG. 1A, in accordance with the principles of the present disclosure.

FIG. 1E is a top perspective exploded view of the first exemplary building-block antenna of FIG. 1A, in accordance with the principles of the present disclosure.

FIGS. 1F-1H are top perspective views of a single-feed variant of the first exemplary building-block antenna of FIG. 1A illustrating feed positions at 0°, 90°, and 180°, respectively, in accordance with the principles of the present disclosure.

FIGS. 1I-1K are top perspective views of a dual-feed variant of the first exemplary building-block antenna of FIG. 1A illustrating feed positions at 0°, 90°, and 180°, respectively, in accordance with the principles of the present disclosure.

FIG. 1L is bottom plan view of a variant of the first exemplary building-block antenna of FIG. 1A illustrating the application of a solder mask as well as a printed circuit board layout for the first exemplary building-block antenna of FIG. 1A, in accordance with the principles of the present disclosure.

FIG. 2A is a top perspective view of a second exemplary building-block antenna, in accordance with the principles of the present disclosure.

FIG. 2B is a top perspective view of the outer antenna structure of the second exemplary building-block antenna of FIG. 2A, in accordance with the principles of the present disclosure.

FIG. 2C is a top perspective view of the middle antenna structure of the second exemplary building-block antenna of FIG. 2A, in accordance with the principles of the present disclosure.

FIG. 2D is a top perspective view of the inner antenna structure of the second exemplary building-block antenna of FIG. 2A, in accordance with the principles of the present disclosure.

FIG. 3A is a smith chart for a prior art stack antenna structure, in accordance with the principles of the present disclosure.

FIG. 3B is a smith chart for the first exemplary building-block antenna of FIG. 1A, in accordance with the principles of the present disclosure.

FIG. 4 is a plot of return loss as a function of frequency for the first exemplary building-block antenna of FIG. 1A as well as for a prior art stack antenna structure, in accordance with the principles of the present disclosure.

FIG. 5 is a plot of antenna efficiency as a function of frequency for the first exemplary building-block antenna of FIG. 1A as well as for a prior art stack antenna structure, in accordance with the principles of the present disclosure.

FIG. 6A is a plot of the antenna radiation characteristics at 1176 MHZ for the first exemplary building-block antenna of FIG. 1A, in accordance with the principles of the present disclosure.

FIG. 6B is a plot of the antenna radiation characteristics at 1575 MHZ for the first exemplary building-block antenna of FIG. 1A, in accordance with the principles of the present disclosure.

FIG. 7A is a plot of the antenna radiation characteristics at 1176 MHZ for a prior art stack antenna structure, in accordance with the principles of the present disclosure.

FIG. 7B is a plot of the antenna radiation characteristics at 1575 MHZ for a prior art stack antenna structure, in accordance with the principles of the present disclosure.

### DESCRIPTION

Detailed descriptions of the various embodiments and variants of the apparatus and methods of the present disclosure are now provided. It is noted that wherever practicable similar or like reference numbers may be used in the figures and may indicate similar or like functionality. The figures depict embodiments of building-block antenna structures as well as exemplary systems that integrate these building-block antenna structures for purposes of illustration only. One skilled in the art will readily recognize from the following description that alternative embodiments of the structures and methods illustrated may be employed without necessarily departing from the principles described herein.

For example, while the various embodiments discussed herein are primarily described in terms of two antenna element and three antenna element building-block antenna structures, it would be readily apparent to one of ordinary skill given the contents of the present disclosure that these building-block antenna structures are merely exemplary and that building-block antenna structures that incorporate four (or more) antenna elements may be readily appreciated based on the building-block antenna structures described herein. Moreover, while primarily discussed in terms of a specific global navigation satellite system (“GNSS”) operating scenario, it would be readily apparent to one of ordinary skill given the contents of the present disclosure that the techniques described herein may be bodily incorporated in other antenna operating scenarios outside of GNSS frequency bands.

### Exemplary Building-Block Antenna Structures—

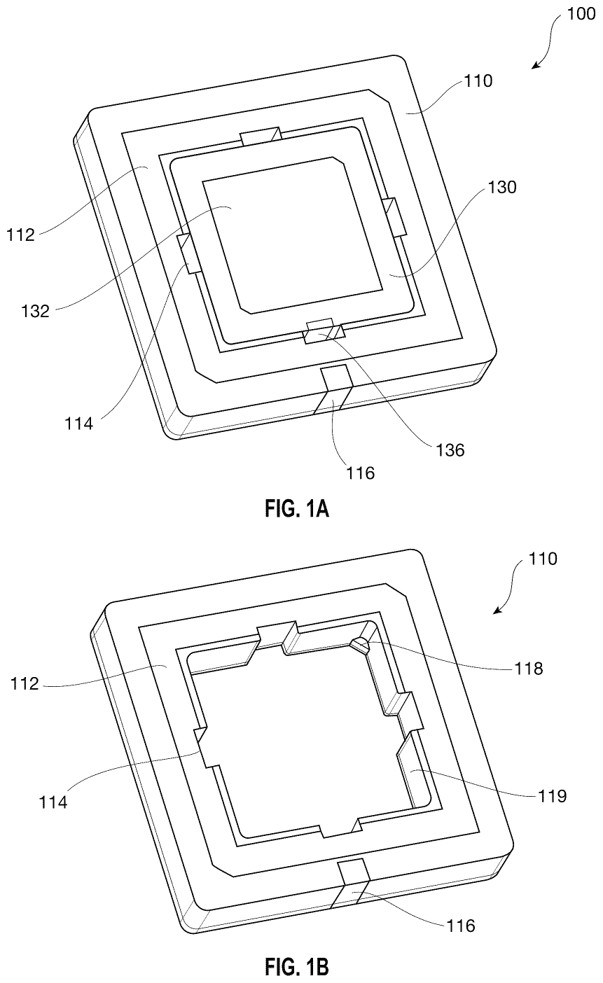

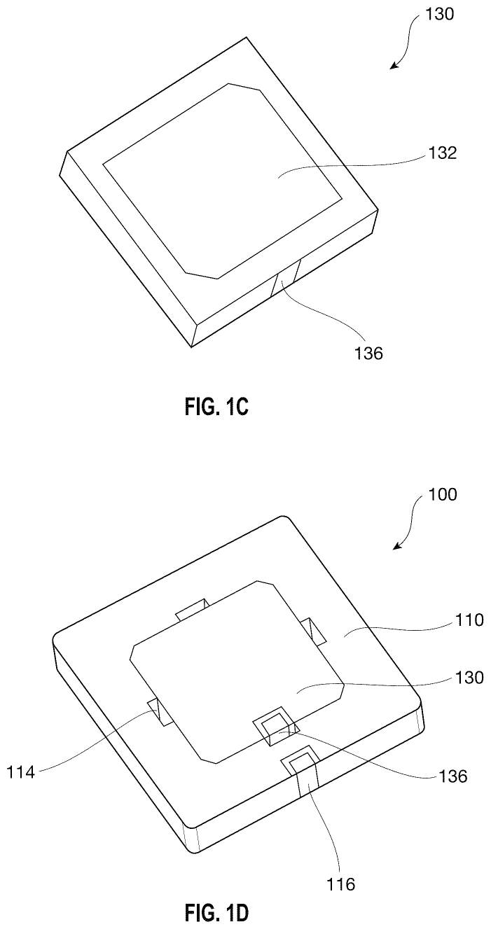

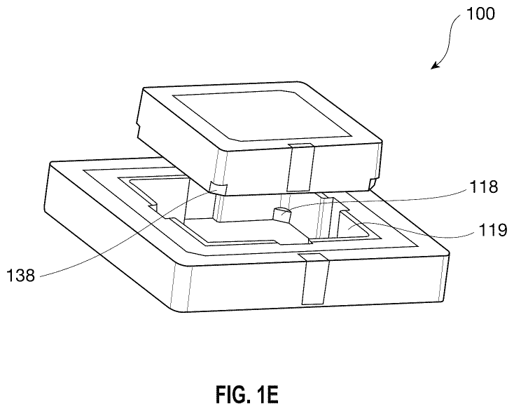

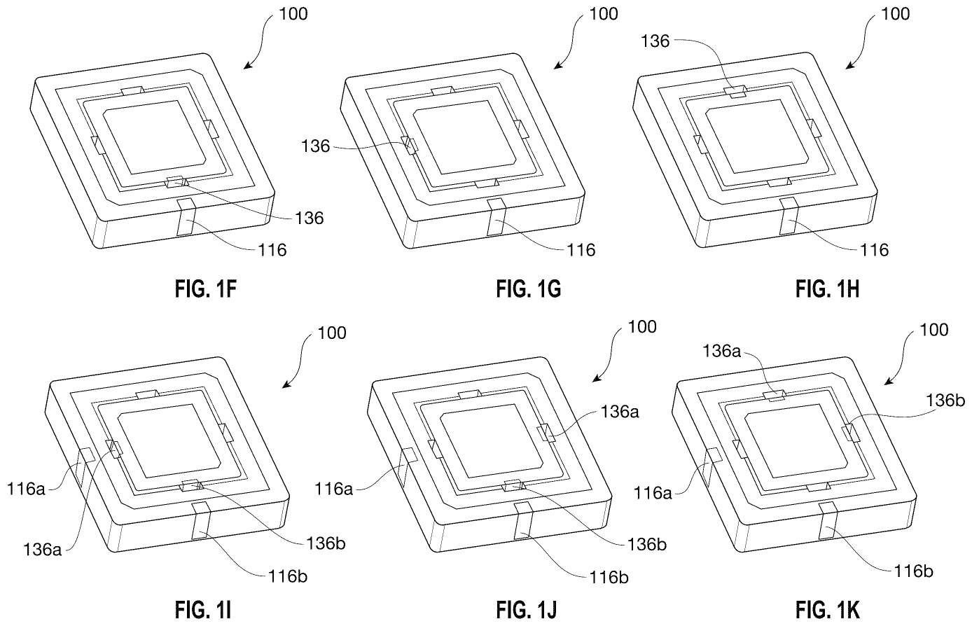

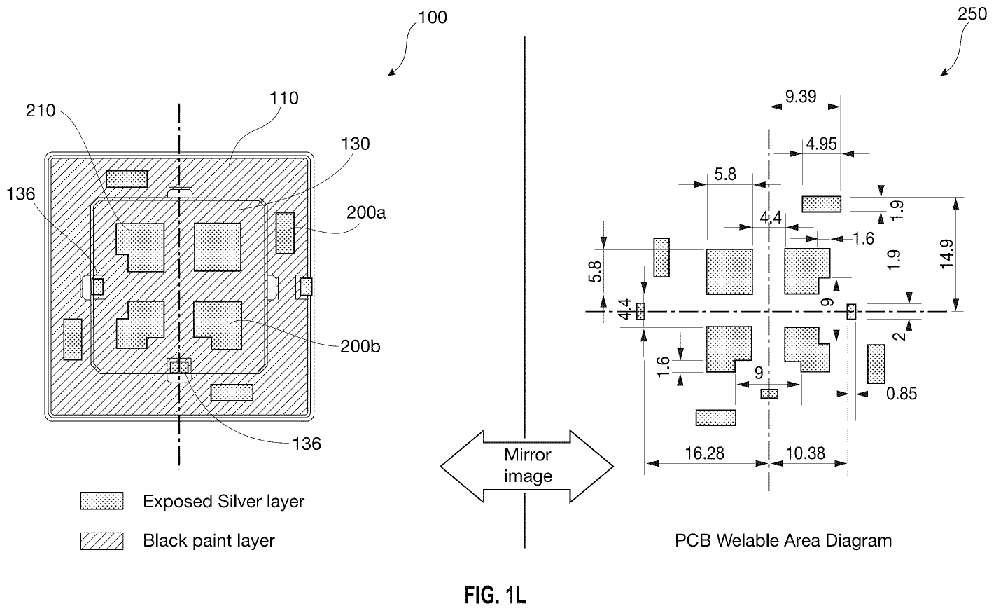

Referring now to FIGS. 1A-1K, a first exemplary building-block antenna structure 100 is shown and described in detail. Specifically, and with reference to FIG. 1A, the first exemplary building-block antenna structure 100 primarily consists of an outer antenna structure 110 as well as an inner antenna structure 130. FIG. 1B illustrates various features of an exemplary outer antenna structure 110. The outer antenna structure 110 may include a generally rectangular outer profile and may be constructed from a ceramic material having a relative permittivity of 63. Specifically, as illustrated in FIG. 1B, the outer antenna structure 110 consists of a square shaped outer profile with the length of each of the sides of the square being of similar length, though it would be recognized by one of ordinary skill given the contents of the present disclosure that one or more of the sides may have a different length than other ones of the sides in alternative variants. Moreover, while the outer antenna structure 110 is illustrated as a four-sided polygon in FIG. 1B, it would be recognized by one of ordinary skill given the contents of the present disclosure that alternative variants may have five or more sides (e.g., a pentagon, hexagon, octagon, etc.) or fewer than four sides (e.g., a triangle, circle, oval, etc.). These and other variants would be readily apparent to one of ordinary skill given the contents of the present disclosure.

Referring again to FIG. 1B, the outer antenna structure 110 may include an outer antenna radiator 112 as well as one or more outer antenna feeds 116. As shown in FIG. 1B, the outer antenna structure 110 only includes a single outer antenna feed 116, though it would be readily appreciated that more than one feed (see, for example, FIGS. 1I-1K which illustrates two outer antenna feeds 116a, 116b) may be utilized in some implementations. The outer antenna radiator 112 may be sized to operate within a given frequency band (e.g., the L5 GPS frequency band at 1176 MHz). The outer antenna structure 110 may also include an inner antenna accommodating perimeter 119. The shape of the inner antenna accommodating perimeter 119 is shown as being square in shape, although it would be readily apparent to one of ordinary skill given the contents of the present disclosure that other shapes having more or less than four (4) sides may be chosen dependent upon, for example, the outer perimeter of the inner antenna structure 130. The inner antenna accommodating perimeter 119 may also include one or more inner feed clearance areas 114. As shown in FIG. 1B, the outer antenna structure 110 includes four (4) inner feed clearance areas 114 with each of the inner feed clearance areas 114 located in the center of each of the sides of the inner antenna accommodating perimeter 119. By having four (4) inner feed clearance areas 114, the inner antenna feed (136, FIG. 1C) for the inner antenna structure 130 may be positioned at 0°, 90°, or 180° for both single feed building-block antennas 100 (see FIGS. 1F-1H) as well as dual feed building-block antennas 100 (see FIGS. 1I-1K). The outer antenna structure 110 may also include an outer antenna alignment feature 118 which may be utilized to help align and/or secure the inner antenna structure 130 to the outer antenna structure 110 (See also FIG. 1E).

Referring now to FIG. 1C, a perspective view of the inner antenna structure 130 is shown and described in detail. The inner antenna structure 130 may be constructed from a ceramic material having a relative permittivity of 20. The inner antenna structure 130 is shown as having a square profile with four (4) sides of equal length, although as mentioned supra, the number of sides and specific outer profile of the inner antenna structure 130 may be varied in alternative variants. Additionally, the inner antenna structure 130 is illustrated as having a single inner antenna feed 136, though it would be readily apparent that alternative implementations may have two or more one inner antenna feeds in some implementations (see, for example, FIGS. 1I-1K). The inner antenna radiator 132 may be sized to operate within a given frequency band (e.g., the L1 GPS frequency band at 1575 MHz). While the building-block antenna structure 100 illustrated in FIG. 1A is intended to collectively operate in the L1 and L5 GPS frequency bands, it would be readily apparent to one of ordinary skill given the contents of the present disclosure that other suitable frequency bands, whether in other GPS frequency bands (e.g., L2 GPS frequency band at 1227.60 MHz) or other communication protocol frequency bands (e.g., cellular, Internet of Things (IoT), etc.), may be readily substituted in alternative implementations.

Referring now to FIG. 1D, the underside of the building-block antenna structure 100 is shown in which the vast majority of both the underside of the inner antenna structure 130 and the outer antenna structure 110 is metallized. The exception to this metallization occurs in the feed clearance areas 114 as well as adjacent to the outer antenna feed 116 as well as the inner antenna feed 136. FIG. 1E illustrates the inner antenna structure alignment features 138 as well as the outer antenna alignment features 118. These alignment features 118, 138 may be utilized to align the outer antenna structure 110 with the inner antenna structure 130 such that the top and bottom surfaces for these antenna structures 110, 130 are substantially coplanar with one another. While the outer antenna alignment features 118 are shown positioned towards the bottom corners of the inner antenna accommodating perimeter 119, it would be readily appreciated by one of ordinary skill given the contents of the present disclosure that these outer antenna alignment features 118 could be positioned towards the top of the inner antenna accommodating perimeter 119 or even in the middle of the inner antenna accommodating perimeter 119 in some implementations. The inner antenna structure 130 and the outer antenna structure 110 may be secured to one another using an adhesive, although it would be readily appreciated by one of ordinary skill given the contents of the present disclosure that alternative fastening means such as, for example, mechanical clips may be utilized in alternative variants.

Referring now to FIG. 1L, a variant of the building-block antenna structure 100 of FIG. 1A is illustrated. Specifically, FIG. 1L illustrates the underside of the building-block antenna structure 100 as well as a PCB layout 250 for the building-block antenna structure 100 illustrated in FIG. 1L. The variant of the building-block antenna structure 100 of FIG. 1A illustrates a solder mask 200 that has been applied to the underside of the building-block antenna structure 100. As illustrated in FIG. 1L, the outer antenna structure 110 includes four solder mask areas 200a and the inner antenna structure 130 also includes four solder mask areas 200b. It has been found that the addition of the solder mask areas 200 to the underside of the building-block antenna structure 100 may be effective in eliminating cracks to the building-block antenna structure 100 caused by unsynchronized thermal expansion during, for example, a solder reflow process.

As a brief aside, cracks to the building-block antenna structure 100 have been found in some manufacturing processes that have been identified as being caused by different coefficients of thermal expansion between the building-block antenna structure 100 and the PCB upon which the building-block antenna structure 100 is mounted and is exacerbated by the ramp-up and ramp-down temperatures of the solder reflow process. This is further exacerbated when the building-block antenna structure 100 is relatively thin (as compared with thicker building-block antenna structures 100) and the sharp right-angled shapes at the corners of both the outer antenna structure 110 and the inner antenna structure 130. These right-angled shapes may lead to stress force concentrations of the corners of the building-block antenna structure 100 resulting in cracks appearing during the solder reflow process.

The solder mask areas 200b for the inner antenna structure 130 may generally be arranged symmetrically around the mid-lines of the inner antenna structure 130. Cutouts 210 may be required for those solder mask areas 200b that are adjacent to the inner antenna feeds 136. These cutouts 210 may assist in eliminating solder connections that could otherwise span between the inner antenna feeds 136 and the solder mask areas 200b. The solder mask areas 200a on the outer antenna structure 110 may be offset from the center line of the building-block antenna structure 100. As a result of the solder mask areas 200a being offset from the inner antenna feeds 136, these solder mask areas 200a may be rectangular in shape without requiring cutout areas 210. When the building-block antenna structure 100 includes these solder mask areas 200 and is mounted to the PCB layout 250 during a solder reflow process, the cracking associated with the building-block antenna structure 100 solder reflow process is eliminated.

Referring now to FIGS. 1F-1H, various permutations of a single feed variant of the building-block antenna structure 100 are shown. FIG. 1F illustrates a variant where the outer antenna feed 116 and the inner antenna feed 136 are positioned on the same side of the building-block antenna structure 100. FIG. 1G illustrates another variant where the outer antenna feed 116 and the inner antenna feed 136 are positioned on different sides of the building-block antenna structure 100 such that they are 90° offset from one another. FIG. 1H illustrates yet another variant where the outer antenna feed 116 and the inner antenna feed 136 are positioned on different sides of the building-block antenna structure 100 such that they are 180° offset from one another.

Referring now to FIGS. 1I-1J, various permutations of a dual feed variant of the building-block antenna structure 100 are shown. FIG. 1I illustrates a variant where the outer antenna feeds 116a, 116b and the inner antenna feeds 136a, 136b are positioned on the same sides of the building-block antenna structure 100. FIG. 1J illustrates another variant where the outer antenna feed 116b and the inner antenna feed 136b are positioned on the same side of the building-block antenna structure 100, while inner antenna feed 136a is positioned 180° offset from the outer antenna feed 116a. FIG. 1K illustrates yet another variant where the outer antenna feed 116b is positioned 90° offset from the inner antenna feed 136a, while the other outer antenna feed 116a is positioned 90° offset from the other inner antenna feed 136a. These and other variants would be readily appreciated by one of ordinary skill given the contents of the present disclosure.

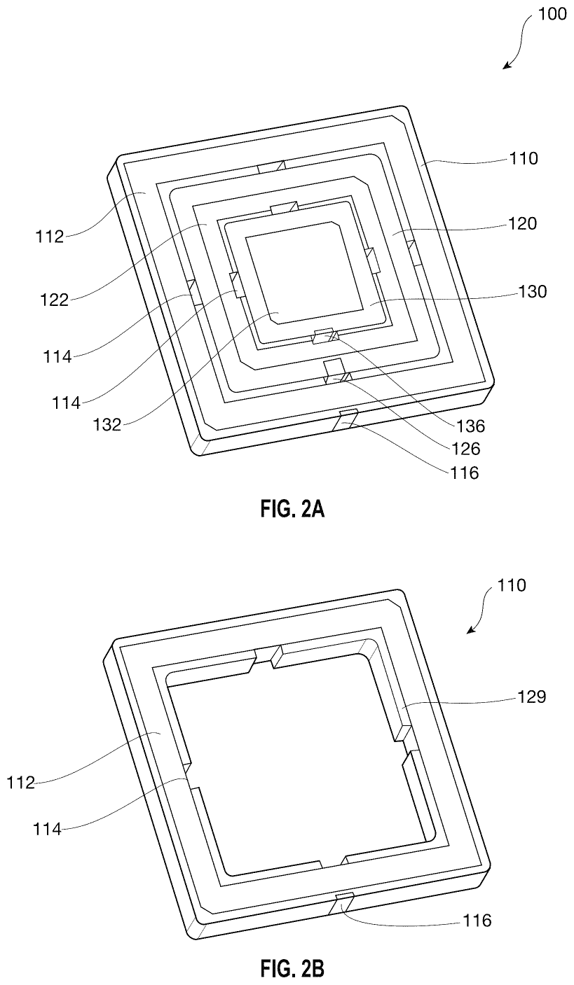

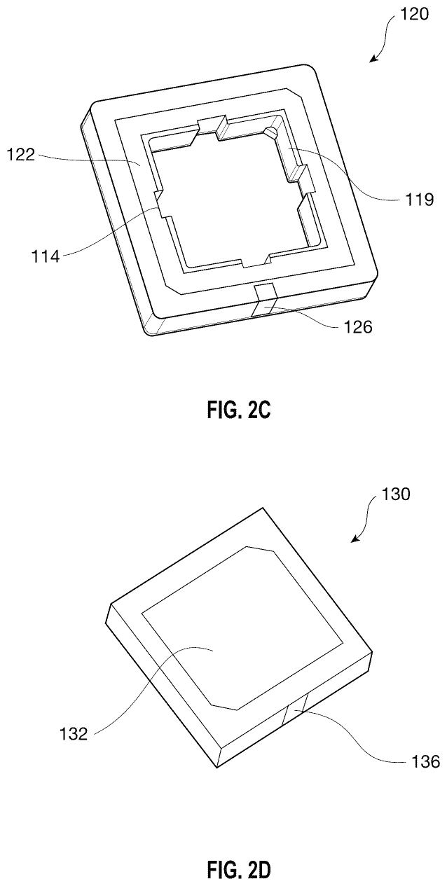

Referring now to FIGS. 2A-2D, a second exemplary building-block antenna structure 100 is shown and described in detail. Specifically, and with reference to FIG. 2A, the second exemplary building-block antenna structure 100 primarily consists of an outer antenna structure 110, an inner antenna structure 130, as well as a middle antenna structure 120. FIG. 2B illustrates various features of an exemplary outer antenna structure 110. The outer antenna structure 110 may include a generally rectangular outer profile. Specifically, as illustrated in FIG. 2B, the outer antenna structure 110 consists of a square shaped outer profile with the length of each of the sides of the square being of similar length, though it would be recognized by one of ordinary skill given the contents of the present disclosure that one or more of the sides may have a different length than other ones of the sides in alternative variants. Moreover, while the outer antenna structure 110 is illustrated as a four-sided polygon in FIG. 2B, it would be recognized by one of ordinary skill given the contents of the present disclosure that alternative variants may have five or more sides (e.g., a pentagon, hexagon, octagon, etc.) or fewer than four sides (e.g., a triangle, circle, oval, etc.). These and other variants would be readily apparent to one of ordinary skill given the contents of the present disclosure.

Referring again to FIG. 2B, the outer antenna structure 110 may include an outer antenna radiator 112 as well as one or more outer antenna feeds 116. As shown in FIG. 2B, the outer antenna structure 110 only includes a single outer antenna feed 116, though it would be readily appreciated that more than one feed (see, for example, FIGS. 1I-1K which illustrates two outer antenna feeds 116a, 116b) may be utilized in some implementations. The outer antenna radiator 112 may be sized to operate within a given frequency band (e.g., the L5 GPS frequency band at 1176 MHz). The outer antenna structure 110 may also include a middle antenna accommodating perimeter 129. The shape of the middle antenna accommodating perimeter 119 is shown as being square in shape, although it would be readily apparent to one of ordinary skill given the contents of the present disclosure that other shapes having more or less than four (4) sides may be chosen dependent upon, for example, the outer perimeter of the middle antenna structure 120. The middle antenna accommodating perimeter 129 may also include one or more middle feed clearance areas 114. As shown in FIG. 2B, the outer antenna structure 110 includes four (4) middle feed clearance areas 114 with each of the middle feed clearance areas 114 located in the center of each of the sides of the middle antenna accommodating perimeter 129. By having four (4) middle feed clearance areas 114, the middle antenna feed (126, FIG. 2A) for the middle antenna structure 120 may be positioned at 0°, 90°, or 180° for both single feed building-block antennas 100 (see FIGS. 1F-1H) as well as dual feed building-block antennas 100 (see FIGS. 1I-1K). The outer antenna structure 110 may also include an outer antenna alignment feature 118 (similar to that described above with reference to FIGS. 1A-1K) which may be utilized to help align and/or secure the middle antenna structure 120 to the outer antenna structure 110.

Referring now to FIG. 2C, the middle antenna structure 110 may include a middle antenna radiator 122 as well as one or more middle antenna feeds 126. As shown in FIG. 2C, the middle antenna structure 120 only includes a single middle antenna feed 126, though it would be readily appreciated that more than one feed (see, for example, FIGS. 1I-1K which illustrates two outer antenna feeds 116a, 116b) may be utilized in some implementations. The middle antenna radiator 122 may be sized to operate within a given frequency band (e.g., the L2 GPS frequency band at 1228 MHz). The middle antenna structure 120 may also include an inner antenna accommodating perimeter 119. The shape of the inner antenna accommodating perimeter 119 is shown as being square in shape, although it would be readily apparent to one of ordinary skill given the contents of the present disclosure that other shapes having more or less than four (4) sides may be chosen dependent upon, for example, the outer perimeter of the inner antenna structure 130. The inner antenna accommodating perimeter 119 may also include one or more inner feed clearance areas 114. As shown in FIG. 2C, the middle antenna structure 120 includes four (4) inner feed clearance areas 114 with each of the inner feed clearance areas 114 located in the center of each of the sides of the inner antenna accommodating perimeter 119. By having four (4) inner feed clearance areas 114, the inner antenna feed (136, FIG. 2D) for the inner antenna structure 130 may be positioned at 0°, 90°, or 180° for both single feed building-block antennas 100 (see, for example, FIGS. 1F-1H) as well as dual feed building-block antennas 100 (see, for example, FIGS. 1I-1K). The middle antenna structure 120 may also include an outer antenna alignment feature 118 (similar to that described above with reference to FIGS. 1A-1K) which may be utilized to help align and/or secure the middle antenna structure 120 to the inner antenna structure 130.

Referring now to FIG. 2D, a perspective view of the inner antenna structure 130 is shown and described in detail. The inner antenna structure 130 is shown as having a square profile with four (4) sides of equal length, although as mentioned supra, the number of sides and specific outer profile of the inner antenna structure 130 may be varied in alternative variants. Additionally, the inner antenna structure 130 is illustrated as having a single inner antenna feed 136, though it would be readily apparent that alternative implementations may have two or more one inner antenna feeds 136 in some implementations (see, for example, FIGS. 1I-1K). The inner antenna radiator 132 may be sized to operate within a given frequency band (e.g., the L1 GPS frequency band at 1575 MHz). While the building-block antenna structure 100 illustrated in FIG. 2A is intended to collectively operate in the L1, L2 and L5 GPS frequency bands, it would be readily apparent to one of ordinary skill given the contents of the present disclosure that other suitable frequency bands, whether in other communication protocol frequency bands (e.g., cellular, Internet of Things (IoT), etc.), may be readily substituted in alternative implementations. Various permutations for the single feed and dual feed second exemplary building-block antenna structure 100 illustrated in FIG. 2A may be envisioned similar to that described supra with respect to FIGS. 1F-1H and FIGS. 1I-1K, albeit with three antenna structures 110, 120, 130 as opposed to the two antenna structures illustrated in, for example, FIG. 1A. Additionally, as previously alluded to above, variants of a building-block antenna structure 100 which include four (or more) antenna structures are also envisioned.

### Exemplary Building-Block Antenna Structure Performance—

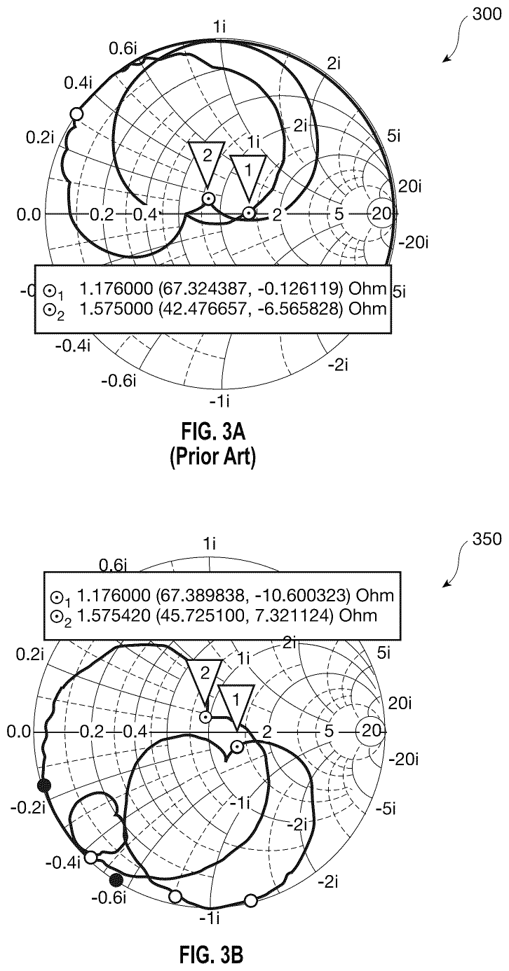

Referring now to FIGS. 3A-5, various performance characteristics of the building-block antenna structure 100 illustrated in FIG. 1A as compared with a prior art stacked antenna structure are shown and described in detail. FIG. 3A illustrates an exemplary smith chart 300 for a prior art stacked antenna structure that is positioned over a 70 mm×70 mm ground plane, while FIG. 3B illustrates a smith chart 350 for the exemplary building-block antenna structure 100 illustrated in FIG. 1A positioned over a similar 70 mm×70 mm ground plane. As illustrated in FIGS. 3A-3B, the building-block antenna structure 100 of FIG. 1A has similar performance characteristics in its intended frequency band operation in the L1 and L5 frequency bands as compared with a prior art stacked antenna structure. In other words, the building-block antenna structure 100 of FIG. 1A may achieve a similar performance with a similar footprint, while being half the height of a prior art stacked antenna structure.

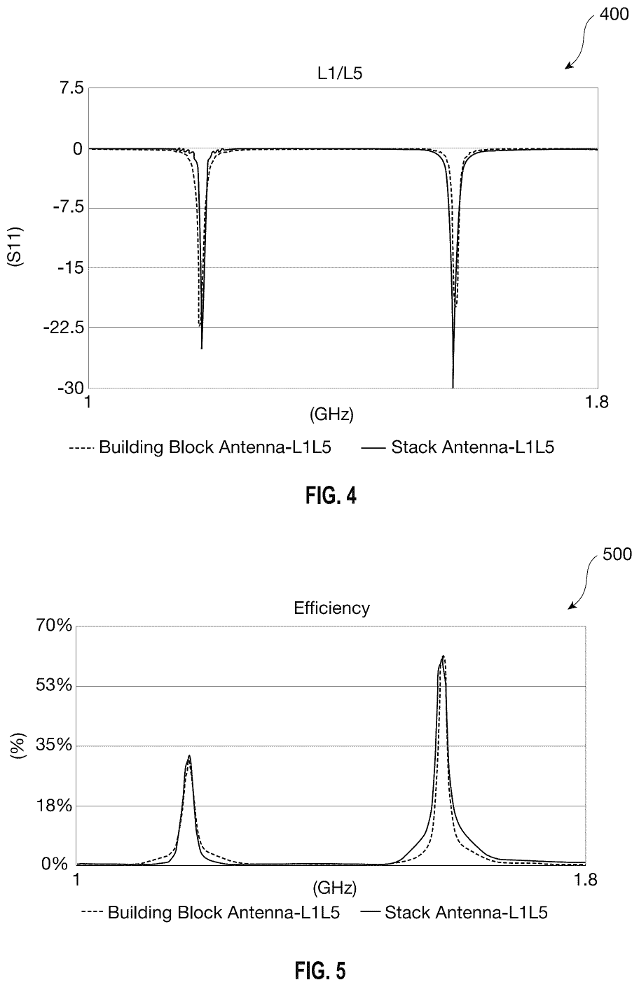

FIG. 4 illustrates a plot 400 of the S11 parameter as a function of frequency for the building-block antenna structure 100 illustrated in FIG. 1A as compared with a prior art stacked antenna structure. As can be seen in the L5 frequency band, the building-block antenna structure 100 of FIG. 1A has an S11 parameter of −22 db at the L5 frequency band, while a prior art stacked antenna structure has an S11 parameter of −25 db at the L5 frequency band. Additionally, at the L1 frequency band, the building-block antenna structure 100 of FIG. 1A has an S11 parameter of −20 db at the L1 frequency band, while a prior art stacked antenna structure has an S11 parameter of −30 db at the L1 frequency band. Again, the plot 400 illustrated in FIG. 4 demonstrates that the building-block antenna structure 100 of FIG. 1A may achieve a similar performance with a similar footprint, while being half the height of a prior art stacked antenna structure.

FIG. 5 illustrates a plot 500 of antenna efficiency as a function of frequency for the building-block antenna structure 100 illustrated in FIG. 1A as compared with a prior art stacked antenna structure. As can be seen in the L5 frequency band, the building-block antenna structure 100 of FIG. 1A has an antenna efficiency of ˜30% at the L5 frequency band, while a prior art stacked antenna structure has a nearly identical antenna efficiency of ˜30% at the L5 frequency band. Additionally, at the L1 frequency band, the building-block antenna structure 100 of FIG. 1A has an antenna efficiency of ˜60% at the L1 frequency band, while a prior art stacked antenna structure has a nearly identical antenna efficiency of ˜60% at the L1 frequency band. Again, the plot 500 illustrated in FIG. 5 demonstrates that the building-block antenna structure 100 of FIG. 1A may achieve a similar performance with a similar footprint, while being half the height of a prior art stacked antenna structure.

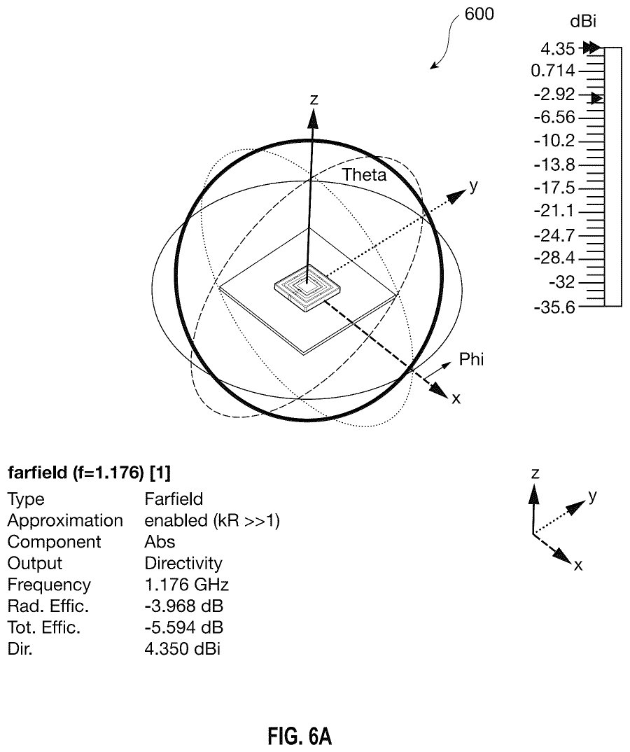

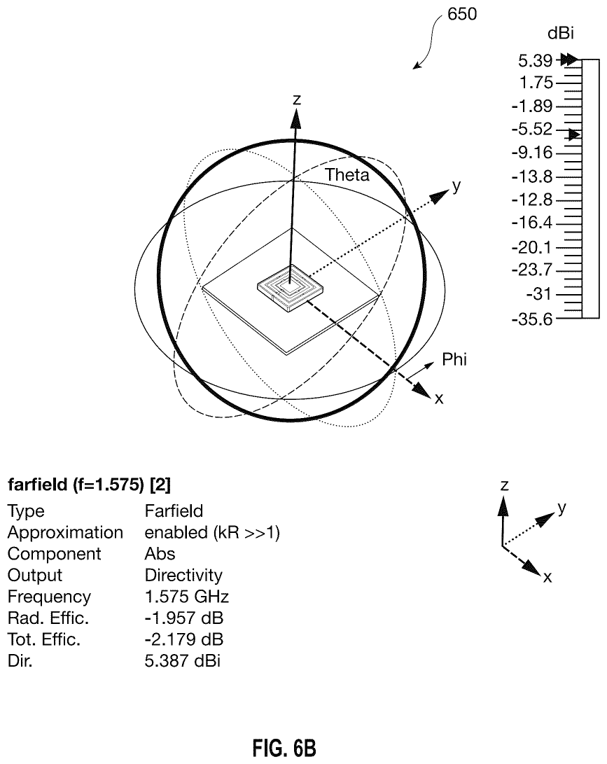

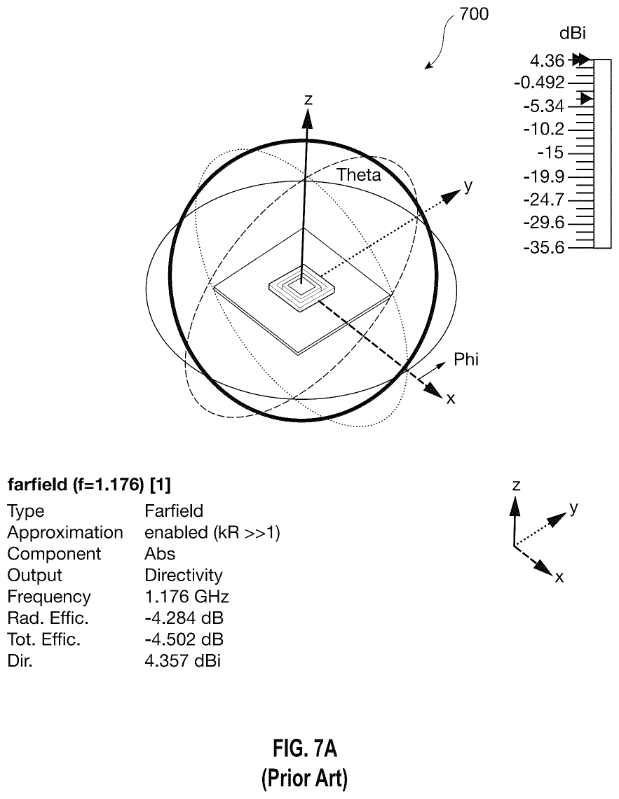

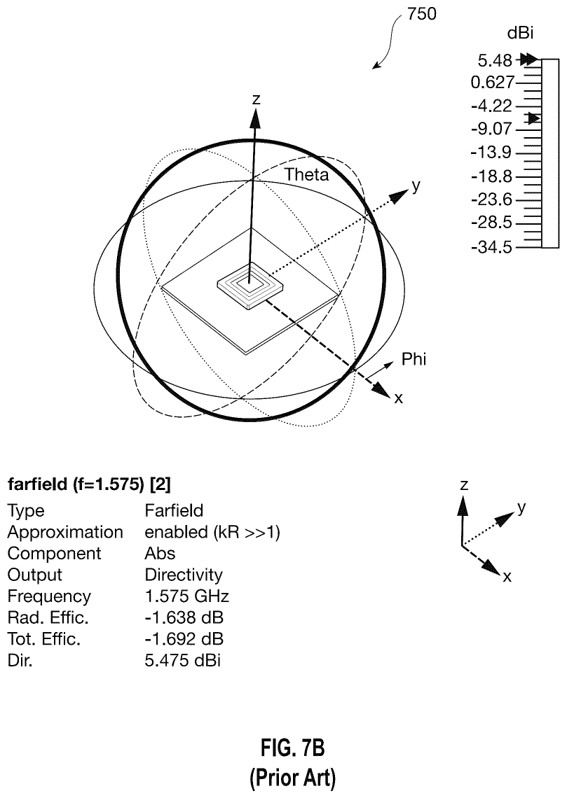

FIG. 6A illustrates the antenna radiation characteristics 600 for the building-block antenna structure 100 illustrated in FIG. 1A at the L5 frequency band, while FIG. 6B illustrates the antenna radiation characteristics 650 for the building-block antenna structure 100 illustrated in FIG. 1A at the L1 frequency band. FIG. 7A illustrates the antenna radiation characteristics 700 for a prior art stacked antenna structure at the L5 frequency band, while FIG. 7B illustrates the antenna radiation characteristics for the prior art stacked antenna structure at the L1 frequency band.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. A building-block antenna structure, the building-block antenna structure comprising:
an outer antenna structure comprising one or more outer antenna feeds and an outer antenna radiator, the outer antenna structure further comprising an inner antenna accommodating perimeter, the inner antenna accommodating perimeter further comprising one or more feed clearance areas, the one or more feed clearance areas configured to accommodate one or more inner antenna feeds; and
an inner antenna structure comprising a perimeter that is similar in shape to the inner antenna accommodating perimeter, the inner antenna structure comprising the one or more inner antenna feeds and an inner antenna radiator;
wherein the outer antenna structure comprises a similar thickness as the inner antenna structure with the outer antenna structure operating at a different frequency band then the inner antenna structure.

2. The building-block antenna structure of claim 1, wherein the one or more outer antenna feeds comprises two outer antenna feeds.

3. The building-block antenna structure of claim 2, wherein the two outer antenna feeds are offset from one another by 90 degrees (90°).

4. The building-block antenna structure of claim 2, wherein the two outer antenna feeds are offset from one another by 180 degrees (180°).

5. The building-block antenna structure of claim 2, wherein the one or more inner antenna feeds comprises two inner antenna feeds.

6. The building-block antenna structure of claim 5, wherein the two inner antenna feeds are positioned in a similar orientation with the two outer antenna feeds.

7. The building-block antenna structure of claim 5, wherein a first inner antenna feed of the two inner antenna feeds is located in a similar orientation with a first outer antenna feed of the two outer antenna feeds; and
wherein a second inner antenna feed of the two inner antenna feeds is offset with a second outer antenna feed of the two outer antenna feeds by ninety degrees (90°).

8. The building-block antenna structure of claim 5, wherein a first inner antenna feed of the two inner antenna feeds is located in a similar orientation with a first outer antenna feed of the two outer antenna feeds; and
wherein a second inner antenna feed of the two inner antenna feeds is offset with a second outer antenna feed of the two outer antenna feeds by one-hundred eighty degrees (180°).

9. The building-block antenna structure of claim 1, wherein the one or more outer antenna feeds comprises a single outer antenna feed; and
wherein the one or more inner antenna feeds comprises a single inner antenna feed.

10. The building-block antenna structure of claim 9, wherein the single outer antenna feed is positioned on a same side of the building-block antenna structure as the single inner antenna feed.

11. The building-block antenna structure of claim 9, wherein the single outer antenna feed is offset from the single inner antenna feed by ninety degrees (90°).

12. The building-block antenna structure of claim 9, wherein the single outer antenna feed is offset from the single inner antenna feed by one-hundred eighty degrees (180°).

13. The building-block antenna structure of claim 1, wherein a plurality of solder mask areas are located on a bottom surface of the outer antenna structure and a bottom surface of the inner antenna structure.

14. The building-block antenna structure of claim 1, wherein the inner antenna structure comprises one or more first alignment features, the one or more first alignment features being configured to engage with one or more second alignment features located on the outer antenna structure.

15. The building-block antenna structure of claim 14, wherein the engagement of the one or more first alignment features with the one or more second alignment features enables a top surface of the inner antenna structure to be coplanar with a top surface of the outer antenna structure.

16. The building-block antenna structure of claim 15, wherein the engagement of the one or more first alignment features with the one or more second alignment features enables a bottom surface of the inner antenna structure to be coplanar with a bottom surface of the outer antenna structure.

17. A building-block antenna structure, the building-block antenna structure comprising:
an outer antenna structure comprising one or more outer antenna feeds and an outer antenna radiator, the outer antenna structure further comprising a middle antenna accommodating perimeter, the middle antenna accommodating perimeter further comprising one or more middle feed clearance areas, the one or more middle feed clearance areas configured to accommodate one or more middle antenna feeds;
a middle antenna structure comprising an external perimeter that is similar in shape to the middle antenna accommodating perimeter, the middle antenna structure further comprising an inner antenna accommodating perimeter, the inner antenna accommodating perimeter further comprising one or more inner feed clearance areas, the one or more inner feed clearance areas configured to accommodate one or more inner antenna feeds; and
an inner antenna structure comprising a perimeter that is similar in shape to the inner antenna accommodating perimeter, the inner antenna structure comprising the one or more inner antenna feeds and an inner antenna radiator.

18. The building-block antenna structure of claim 17, wherein the outer antenna structure comprises a similar thickness as the middle antenna structure and the inner antenna structure.

19. The building-block antenna structure of claim 18, wherein the outer antenna structure operates at a different frequency band then the inner antenna structure.

20. The building-block antenna structure of claim 19, wherein the middle antenna structure operates at a different frequency band then both the inner antenna structure and the outer antenna structure.
